(19) United States
(12) Patent Application Publication
(10) Pub. No.: US 2011/0178757 A1
(43) Pub. Date: Jul. 21, 2011

(54) ERROR ASSESSMENT METHOD FOR TEST STIMULUS SIGNAL OF ANALOG TO DIGITAL CONVERTER

(76) Inventors: Chun-Wei LIN, Yunlin County (TW); Yi-Chou LIN, Yunlin County (TW)

(21) Appl. No.: 12/691,324

(22) Filed: Jan. 21, 2010

(51) Int. Cl. G06F 19/00; G06F 17/18

(52) U.S. Cl. 702/119; 702/181

(57) ABSTRACT

An error assessment method for a test stimulus signal of an analog to digital converter is disclosed. The method provides random uniform-distribution test signals for an analog to digital converter (ADC), derives the piecewise linearity relationship between the input signals and the output signals of the ADC and thus develops an error assessment method for a test stimulus signal of the ADC. The method is able to reduce the computational complexity but still accurate and effective, and thereby provides correct information of the test stimulus signals for testing the ADC to improve its correctness.

### FIELD OF THE INVENTION

The present invention relates to a method for testing an analog to digital converter, particularly to an error assessment method for a test stimulus signal of an analog to digital converter.

### BACKGROUND OF THE INVENTION

With the evolution of IC technology, the transistor density of a chip grows rapidly. Thus, an electronic circuit system becomes more and more complicated, and the test thereof becomes more and more difficult, particularly the test of an analog circuit or a mixed-signal circuit. The mixed-signal circuit demands a stricter tolerance and thus needs high-precision signal sources and test devices.

Among the mixed-signal circuits, the analog to digital converter (ADC) is an element responsible for converting analog signals into digital signals. With the advance of IC technology, more and more high-complexity mixed-signal circuits need high-resolution and high-precision analog to digital converters. However, the assessment of a high-resolution and high-precision analog to digital converter usually needs higher-level test devices. Thus, the cost of circuit test increases significantly.

Refer to FIG. 1 for a conventional ADC test architecture. A digital to analog converter (DAC) 2 converts a digital input signal Di into an analog signal. An adder 1 adds an analog eigenvalue signal w to the analog signal to form a test stimulus signal. An analog to digital converter (ADC) 3 converts the test stimulus signal into a digital output signal Do. Then, the ADC 3 is assessed via comparing the digital input signal Di and the digital output signal Do.

There have been many achievements in ADC tests, such as the tests of static parameters, including the tests of offset voltage, gain error, DNL (Differential Nonlinearity Error), and INL (Integral Nonlinearity Error). All the aforementioned tests need a precision test stimulus signal having fine test eigenvalues. Only a precision test signal generator can generate a fine test signal. No matter what precision a signal generator has, the stimulus signal generated thereby always has an error, which causes an incorrect test result.

### SUMMARY OF THE INVENTION

The primary objective of the present invention is to provide an error assessment method, which is based on the principles of probability and statistics, and which uses a piecewise linearity relationship between input signals of an analog to digital converter and output signals of a test pattern generator to assess the error of a test stimulus signal of the analog to digital converter.

To achieve the abovementioned objective, the present invention inputs a uniform-distribution test signal and deduces the piecewise linearity relationship of the input signal and output signal of ADC according to the principles of probability and statistics. Then, the present invention simplifies the linearity relationship to realize an error assessment method for the test stimulus signal of an analog to digital converter effective error assessment method for an ADC test stimulus signal.

The uniform-distribution test signal can be generated by a hardware circuit easily. Further, the present invention uses simple equations to assess errors and thus reduces computational complexity. Besides, the result of error assessment can provide useful information to correct the test result in testing ADC.

### BRIEF DESCRIPTION OF THE DRAWINGS

FIG. 1 is a diagram schematically showing a conventional ADC test architecture;

FIG. 2 is a diagram schematically showing a conversion relationship between voltages and digital codes;

FIG. 3 is a diagram schematically showing a piecewise linearity relationship obtained from uniform-distribution signals;

FIG. 4 is a diagram schematically showing a linearity relationship wherein a transition level of ADC is greater than that of DAC;

FIG. 5 is a diagram schematically showing a linearity relationship wherein a transition level of DAC is greater than that of ADC;

FIG. 6 is a diagram schematically showing various cases of code missing in ADC; and

FIG. 7 is a diagram schematically showing a relationship between the averages of input signals and output signals.

### DETAILED DESCRIPTION OF THE PREFERRED EMBODIMENTS

Below, the embodiments are described in detail in cooperation with the drawings to make easily understood the objectives, characteristics and efficacies of the present invention.

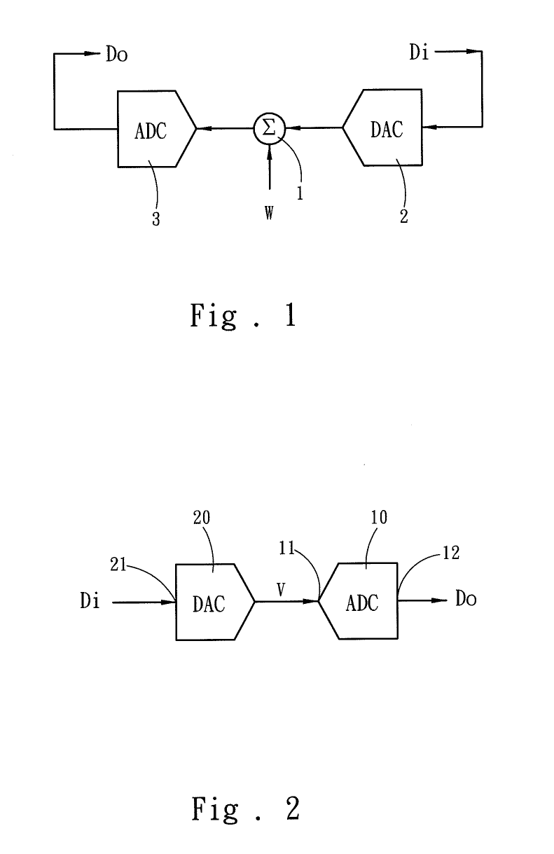

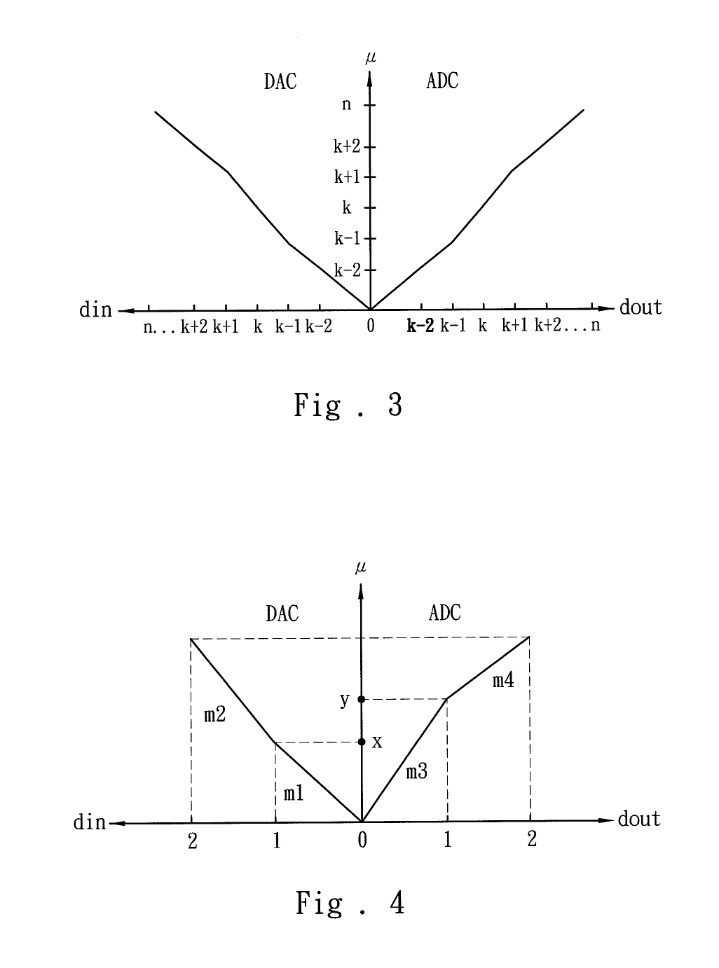

Refer to FIG. 2 and FIG. 3. The present invention proposes an error assessment method for a test stimulus signal of an analog to digital converter, wherein an analog to digital converter (ADC) 10 receives a uniform-distribution test signal V via an analog input terminal 11 thereof and sends out a digital uniform-distribution output signal Do from a digital output terminal 12 thereof.

A conversion relationship exists between the input signal and output digital code of the ADC 10. When the input signal is uniformly distributed, the output signal is also uniformly distributed. Thus, the principles of probability and statistics are used to find out the conversion relationship.

The relationship of the digital code and a transition level of the ADC 10 can be deduced from the cumulative distribution function of the input signal:

F_{V}(v)=P(V≦v)=Y (1.1)

Wherein −□<v<□, and 0<y<1. The cumulative distribution function of Y is expressed by:

$$\begin{matrix}{F}_{Y} ( y ) = P ( Y \leq y ) \\ = P ( {F}_{V} ( v ) \leq y ) \\ = P ( V \leq {F}_{V}^{- 1} ( y ) ) \\ = {F}_{V} ( {F}_{V}^{- 1} ( y ) ) \\ = y\end{matrix} \qquad ( 1.2 )$$

The probability density function of Y is expressed by

$${f}_{Y} ( y ) = \frac{d {F}_{Y } ( y )}{d y} = \{ \begin{matrix}1 , & 0 \leq y \leq 1 \\ 0 , & otherwise\end{matrix} \qquad ( 1.3 )$$

From the above equations, it is known that the variable Y is distributed uniformly, and that V is also distributed uniformly in a range (a, b). In the range (a, b), the input signal thus can be expressed by the following equations:

$$\begin{matrix}{F}_{V} ( v ) = P ( V < v ) \\ = {\int }_{a}^{V} \frac{1}{b - a} d V \\ = \frac{v - a}{b - a} \\ = \frac{Δ v}{b - a}\end{matrix} \qquad ( 1.4 )$$

Also, the cumulative distribution function of Y can be expressed by

F_{Y}(y)=P(Y<y)=∫₀^{y}1dY=y (1.5)

From Equations (1.4) and (1.5) is obtained the relationship of the input voltage V and the conversion function H (V):

$$Y = \frac{Δ V}{b - a} \qquad ( 1.6 )$$

Via a similar way is obtained the conversion function G (V) and the output digital code:

$$Y = \frac{Δ D}{c - d} \qquad ( 1.7 )$$

From Equations (1.6) and (1.7) is deduced a simple piecewise linearity equation:

E[ΔV]=k·E[ΔD] (1.8)

Wherein E[ΔV] and E[ΔD] are respectively the average value of the input signals and the average value of the output signals.

When the input signal is distributed uniformly, both the input signal and output digital code of the ADC 10 are piecewise linear. A similar case also occurs in a digital to analog converter (DAC) 20, as shown in FIG. 3.

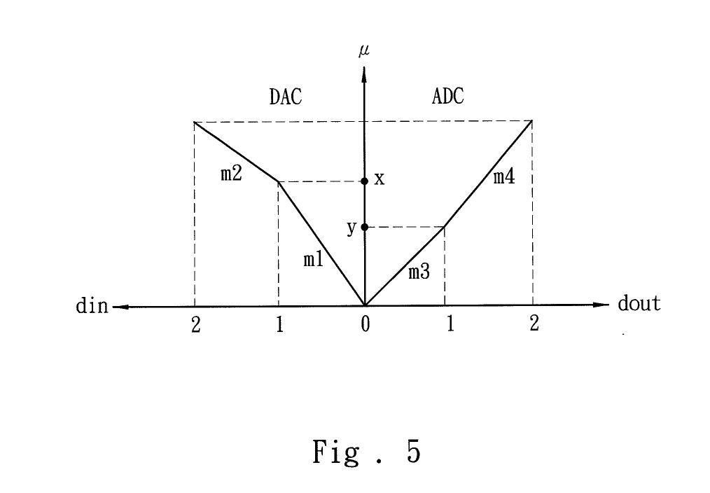

Refer to FIG. 2, FIG. 4 and FIG. 5. Thus, the present invention can assess the error of a test pattern generator (i.e. the error of a test stimulus signal). The method of the present invention is described as follows. Let the DAC 20 acts as the test pattern generator, and the input digital signal Di be distributed uniformly. The resultant signal obtained from the D/A (digital to analog) conversion and the A/D (analog to digital) conversion of the input digital signal Di is also distributed uniformly. When the input digital signal Di is processed by the D/A conversion and the A/D conversion, the quantization errors of the DAC 20 and the ADC 10 will result in two cases respectively shown in FIG. 4 and FIG. 5. FIG. 4 and FIG. 5 show the results of the normalization and simplification of FIG. 3, wherein the digital code posterior to the (k+1)th digital code is normalized to be 2, and the kth digital code is normalized to be 1, and the digital code anterior to the (k−1)th digital code is normalized to be 0.

In FIG. 4, x and y are respectively transition levels of the DAC 20 and the ADC 10; m1, m2, m3, and m4 are respectively the slopes obtained via normalizing the linearity relationships of specific quantization interval. For the slopes m1 and m2 of the DAC 20, m1=X, and m2=2−x, with the input code being the X axis and μ being the Y axis. For the slopes m3 and m4 of the DAC 20, m3=1/y, and m4=1/(2−y), with μ being the X axis and the output code being the Y axis. From FIG. 4, it is known that

$$\frac{d out}{d i n}$$

includes three cases: m1×m3, m2×m3 and m2×m4, which can be respectively expressed by:

$$\{ \begin{matrix}m 1 \times m 3 = \frac{x}{y} \\ m 2 \times m 3 = \frac{2 - x}{y} \\ m 2 \times m 4 = \frac{2 - x}{2 - y}\end{matrix} \qquad ( 1.9 )$$

Arranging the three equations and thus obtaining the relationship of the transition level x:

$$x = \frac{2}{1 + \frac{m 2 \times m 3}{m 1 \times m 3}} \qquad ( 1.10 )$$

For the dout/din corresponding to m1×m3, E[din]≦1, and E[out]≦1. For the dout/din corresponding to m2×m3, E[din]≧1 and E[out]≦1.

Similarly, it is known from FIG. 5 that for the slopes m1-m4, m1=x, m2=2−x, m3=1/y and m4=1/(2−y), and that the relationships of the input and the output are respectively expressed by

$$\begin{matrix}\{ \begin{matrix}m 1 \times m 3 = \frac{x}{y} \\ m 1 \times m 4 = \frac{x}{2 - y} \\ m 2 \times m 4 = \frac{2 - x}{2 - y} ,\end{matrix} \\ and that & ( 1.11 ) \\ x = \frac{2}{1 + \frac{m 2 \times m 4}{m 1 \times m 4}} & ( 1.12 )\end{matrix}$$

For the dout/din corresponding to m1×m4, E[din]≦1, and E[dout]≧1. For the dout/din corresponding to m2×m4, E[din]≧1 and E[dout]≧1.

As mentioned above, when the input digital signal Di that is distributed uniformly within an appropriate range is inputted into the test pattern generator, the signal collected in the digital output terminal 12 of the ADC 10 can be used to deduce the relationship of the transition levels of the test pattern generator according to Equations (1.10) or (1.12). Then, the error of the test stimulus signal can also be deduced therefrom.

When a missing code appears in the ADC 10, the method of the present invention should be modified appropriately to maintain the precision of the assessment result.

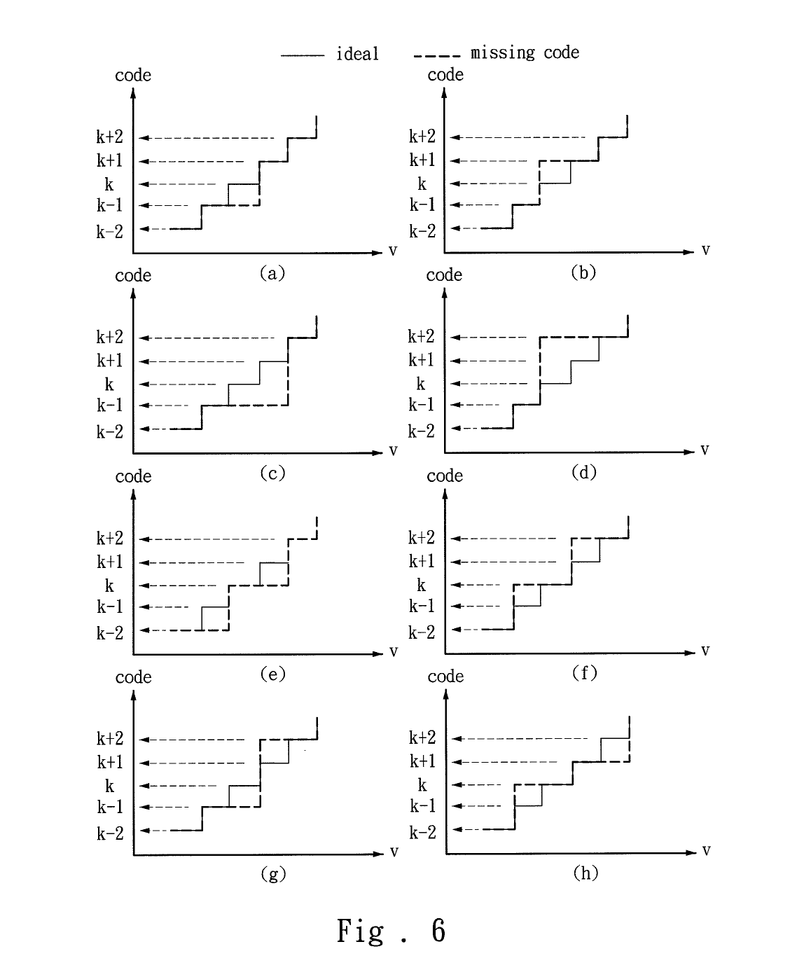

Refer to FIG. 6 for the influence of the input signal and output signal as the ADC 10 appears the missing code. The missing code may be categorized into several cases. When the ADC 10 has the missing code, the conversion waveforms are shown in FIG. 6. A first case is shown in Graph (a) or (b) of FIG. 6. Suppose that the ADC 10 has the missing code in the kth code. When a voltage signal correspond to the kth code is sent into the analog input terminal 11 of the ADC 10, the digital output terminal 12 outputs the value corresponding to the (k−1)th code or the (k+1)th code at the position corresponding to the kth code.

A second case is that two successive digital codes are missed in the ADC 10, and the outputs are shown in Graph (c) or (d) of FIG. 6. Suppose that the ADC 10 has the missing codes in two successive digital codes—the kth and the (k+1)th digital codes. When the voltage signals of the kth and the (k+1) digital codes are sent into the analog input terminal 11 of the ADC 10, the digital output terminal 12 outputs the value corresponding to the (k−1)th code or the (k+2)th code at the positions corresponding to the kth and (k+1)th codes.

A third case is different from the second case in that the third case has two discrete missing codes. In the third case, the two missing codes have the same directivity. When the voltage signals of the (k+1)th and (k−1)th codes are sent into the analog input terminal 11 of the ADC 10, the digital output terminal 12 respectively outputs the values corresponding to the kth code and the (k−2)th code at the positions corresponding to the (k+1)th and (k−1)th codes, as shown in Graph (e) of FIG. 6, or respectively outputs the values corresponding to the (k+2)th code and the kth code at the positions corresponding to the (k+1)th and (k−1)th codes, as shown in Graph (f) of FIG. 6.

A fourth case is similar to the third case in that the fourth case also has two discrete missing codes, but different from the third case in that the two missing codes have opposite directivities. In the fourth case, the ADC 10 converts the (k+1)th code to the (k+2)th code and also converts the kth code to the (k−1)th code, as shown in Graph (g) of FIG. 6. Alternatively, the ADC 10 converts the (k+2)th code to the (k+1)th code and also converts the (k−1)th code to the kth code, as shown in Graph (h) of FIG. 6.

The code missing of the ADC 10 results in two types of effects—Type A and Type B. Type A includes the instances shown in Graphs (a), (c) and (e) of FIG. 6. In these instances, when the voltage signal of the kth code is sent into the analog input terminal 11 of the ADC 10, the digital output terminal 12 outputs the value corresponding to the (k−1)th code. Such an effect causes that the average values of data received from the digital output terminal 12 becomes smaller.

Type B includes the instances shown in Graphs (b), (d) and (f) of FIG. 6. In these instances, when the voltage signal of the kth code is sent into the analog input terminal 11 of ADC 10, the digital output terminal 12 outputs the value corresponding to the (k+1)th code. Such an effect causes that the average values of data received from the digital output terminal 12 becomes greater. The instances of Graph (g) or (h) of FIG. 6 may be regarded as the combinations of Graphs (a) and (b) of FIG. 6. The instance of Graph (g) or (h) of FIG. 6 may be handled separately.

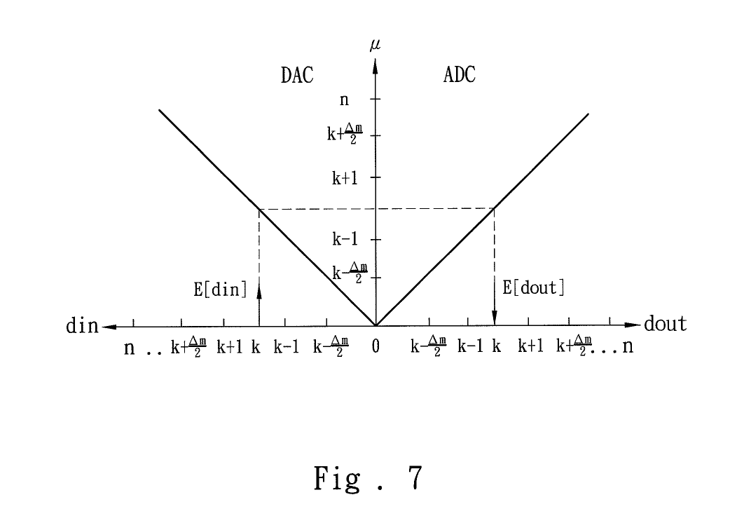

Refer to FIG. 7. Suppose that the DAC 20 and the ADC 10 are ideal converters. When the digital input terminal 21 of the DAC 20 receives Nₚₐₜ, pieces of uniform-distribution digital input signals Di distributed in a range of (k−Δm/2, k+Δm/2), the number of the test patterns distributed to each digital code within the range is equal to:

$$\frac{{N}_{pat .}}{( k + Δ m / 2 ) - ( k - Δ m / 2 )} = \frac{{N}_{pat .}}{Δ m} \qquad ( 2.1 )$$

The average of the input test patterns is equal to:

$$\frac{[ \begin{matrix}\frac{{N}_{pat .}}{Δ m} ( {k}_{i n} + \frac{Δ m}{2} ) + \frac{{N}_{pat .}}{Δ m} ( {k}_{i n} + \frac{Δ m}{2} - 1 ) + … + \\ \frac{{N}_{pat .}}{Δ m} ( {k}_{i n} + 1 ) + \frac{{N}_{pat .}}{Δ m} {k}_{ i n} + \frac{{N}_{pat .}}{Δ m} ( {k}_{i n} - 1 ) + … + \\ \frac{{N}_{pat .}}{Δ m} ( {k}_{i n} - \frac{Δ m}{2} + 1 ) + \frac{{N}_{pat .}}{Δ m} ( {k}_{i n} - \frac{Δ m}{2} )\end{matrix} ]}{( {N}_{pat .} )} = \frac{\frac{{N}_{pat .}}{Δ m} [ \begin{matrix}( {k}_{i n} + \frac{Δ m}{2} ) + ( {k}_{i n} + \frac{Δ m}{2} - 1 ) + … + \\ ( {k}_{ i n} + 1 ) + {k}_{i n} + ( {k}_{i n} - 1 ) + … + \\ ( {k}_{i n} - \frac{Δ m}{2} + 1 ) + ( {k}_{i n} - \frac{Δ m}{2} )\end{matrix} ]}{{N}_{pat .}} = \frac{1}{Δ m} ( Δ m \times {k}_{i n} ) = {k}_{i n} \qquad ( 2.2 )$$

When the input signals are distributed uniformly, the output signals will be distributed uniformly also. When the DAC 20 and the ADC 10 are ideal converters, the average of the output signals can be obtained via a way similar to that of obtaining Equation (2.2) and is equal to:

$$\frac{\frac{{N}_{pat .}}{Δ m} [ \begin{matrix}( {k}_{out} + \frac{Δ m}{2} ) + ( {k}_{out} + \frac{Δ m}{2} - 1 ) + … + \\ ( {k}_{out} + 1 ) + {k}_{out} + ( {k}_{out} - 1 ) + … + \\ ( {k}_{out} - \frac{Δ m}{2} + 1 ) + ( {k}_{out} - \frac{Δ m}{2} )\end{matrix} ]}{{N}_{pat .}} = \frac{1}{Δ m} ( Δ m \times {k}_{out} ) = {k}_{out} \qquad ( 2.3 )$$

Suppose that the converters are all ideal converters. When the uniform-distribution test patterns having an average of Kin are inputted, the output will have an average of Kout, and kᵢₙ=kₒᵤₜ=k. In other words, inputting the uniform-distribution test patterns with an average of k will obtain the output signals also with an average of k.

When the ADC 10 has a missing code and is in a case similar to that shown in Graph (a) of FIG. 6, the output signal corresponding to the kth code has the value corresponding to the (k−1)th code. Via a similar way, the influence of this type of missing code on the average of the output signals can be obtained:

$$\frac{\frac{{N}_{pat .}}{Δ m} [ \begin{matrix}\begin{matrix}( k + \frac{Δ m}{2} ) + ( k + \frac{Δ m}{2} - 1 ) + … + ( k + 1 ) + \\ ( k - 1 ) + ( k - 1 ) + … + ( k - \frac{Δ m}{2} + 1 ) +\end{matrix} \\ ( k - \frac{Δ m}{2} )\end{matrix} ]}{{N}_{pat .}} = \frac{1}{Δ m} [ Δ m \times k - 1 ] = k - \frac{1}{Δ m} \qquad ( 2.4 )$$

From Equation (2.4), it is known that the missing code of the ADC 10, such as that in Graph (a) of FIG. 6, causes a decrease of

$$\frac{1}{Δ m}$$

in the average of the output signals.

When the ADC 10 has the missing code and is in a case similar to that shown in Graph (b) of FIG. 6, the output signal corresponding to the kth code has the value corresponding to the (k+1)th code. Via a similar way, the influence of this type of missing code on the average of the output signals can be obtained:

$$\frac{\frac{{N}_{pat .}}{Δ m} [ \begin{matrix}( k + \frac{Δ m}{2} ) + ( k + \frac{Δ m}{2} - 1 ) + … + ( k + 1 ) + \\ ( k + 1 ) + ( k - 1 ) + … + ( k - \frac{Δ m}{2} + 1 ) + \\ ( k - \frac{Δ m}{2} )\end{matrix} ]}{{N}_{pat .}} = \frac{1}{Δ m} [ Δ m \times k + 1 ] = k + \frac{1}{Δ m} \qquad ( 2.5 )$$

From Equation (2.5), it is known that the missing code of the ADC 10, such as that in Graph (b) of FIG. 6, causes an increase of

$$\frac{1}{Δ m}$$

in the average of the output signals.

From Equations (2.4) and (2.5), it is known that the missing code of the ADC 10 causes a variation of

$$\pm \frac{1}{Δ m} ( Δ θ )$$

in the average of the output signals

When the ADC 10 has two successive missing codes and is in a case similar to that shown in Graphs (c) or (d) of FIG. 6, the variation of the average of the output signals can be obtained similarly:

$$\frac{\frac{{N}_{pat .}}{Δ m} [ \begin{matrix}\begin{matrix}( k + \frac{Δ m}{2} ) + ( k + \frac{Δ m}{2} - 1 ) + … + ( k + 2 ) + \\ ( k - 1 ) + ( k - 1 ) + ( k - 1 ) + ( k - 2 ) + … +\end{matrix} \\ ( k - \frac{Δ m}{2} + 1 ) + ( k - \frac{Δ m}{2} )\end{matrix} ]}{{N}_{pat .}} = k - \frac{3}{Δ m} \qquad ( 2.6 )$$

Equation (2.6) expresses the variation when the ADC 10 converts the two successive kth and (k+1)th codes to the (k−1)th code. And Equation (2.7) expresses the variation when the ADC 10 converts the kth and (k−1)th codes to the (k+1)th code.

$$\frac{\frac{{N}_{pat .}}{Δ m} [ \begin{matrix}( k + \frac{Δ m}{2} ) + ( k + \frac{Δ m}{2} - 1 ) + … + ( k + 2 ) + \\ ( k + 1 ) + ( k + 1 ) + ( k - 2 ) + … + ( k - \frac{Δ m}{2} + 1 ) + \\ ( k - \frac{Δ m}{2} )\end{matrix} ]}{{N}_{pat .}} = k + \frac{3}{Δ m} \qquad ( 2.7 )$$

Via similar ways can be worked out the variations of the averages of the output signals caused by the missing codes in various cases. Table.1 shows the number of the successive missing codes and the influence thereof on the average of the output signals of the ADC 10. Table.2 shows the number of the discrete missing codes (such as those shown in Graph (e) or (f) of FIG. 6) and the influence thereof on the average of the output signals of the ADC 10. The ADC 10 may have various cases of missing codes. However, any cases of code missing can be simplified to be an instance shown in Table.1 or Table.2 via appropriately choosing the test patterns and the input interval (Δm).

TABLE 1
the relationship between the number of the successive missing codes
and the variation of the average of the output signals of the ADC 10.

| Number of Successive Missing Codes | Variation^{(Δθ)} |
|---|---|
| 1 | $\pm \frac{1}{Δm}$ |
| 2 | $\pm \frac{3}{Δm}$ |
| 3 | $\pm \frac{6}{Δm}$ |
| $⋮$ | $⋮$ |
| n | $\pm \frac{{\sum }_{i = 0}^{n} i}{Δm}$ |

TABLE 2
the relationship between the number of the discrete missing codes and
the variation of the average of the output signals of the ADC 10.

| Number of Discrete Missing Codes | Variation (Δθ) |
|---|---|
| 2 | $\pm \frac{2}{Δm}$ |
| 3 | $\pm \frac{3}{Δm}$ |
| 4 | $\pm \frac{4}{Δm}$ |
| $⋮$ | $⋮$ |
| N | $\pm \frac{n}{Δm}$ |

Suppose that the DAC 20 and the ADC 10 are ideal converters, and that none noise exists. Based on the relationship of the missing codes and the variation of the average of the output signals of the ADC 10, the relationship between the input signals and the output signals can be expressed by

$$E [ di n ] \cdot x \cdot \frac{1}{y} = E [ dout ] \qquad ( 2.8 )$$

As the values of x and y are equal to 1 after normalization, Equation (2.8) can be further expressed by

E[din]=E[out] (2.9)

When there is code missing in the ADC 10, the difference Δθ between the average of the input signals and the average of the output signals can be expressed by

$$E [ di n ] \cdot x \cdot \frac{1}{{y}^{′ }} = E [ dout ] \pm Δ θ \qquad ( 2.10 )$$

wherein y′ is the pseudo quantization level of the ADC 10, and Δθ is the difference caused by code missing. Suppose that y′ is equal to 1, and that the normalized average of the test patterns is also equal to 1. Thus, Equation (2.10) can be simplified to be

x=E[dout]±Δθ (2.11)

Thus is obtained the transition level x of the DAC 20 (i.e. the test pattern generator).

Based on the principles of probability and statistics, the present invention provides uniform-distribution test signals for ADC, derives the piecewise linearity relationship between the input signals and the output signals and then develops an error assessment method for a test stimulus signal of ADC. A hardware circuit can easily generate the random uniform-distribution test patterns required by the assessment method of the present invention. Further, the method of the present invention uses simple equations to assess the error. Thus is reduced the computational complexity. The assessed error can be used to correct the inaccurate test result and provide more effective information during an ADC test.

What is claimed is:

1. An error assessment method for a test stimulus signal of an analog to digital converter comprising
generating an uniform-distribution digital code;
inputting the uniform-distribution digital code to a test pattern generator to generate a uniform-distribution signal;
using principles of probability and statistics to derive a piecewise linearity relationship between input signals of an analog to digital converter and output signals of the test pattern generator; and
inputting the uniform-distribution signal to the analog-digital converter to generate a digital output signal and substituting the digital output signal into the piecewise linearity relationship to obtain a transition level of the test pattern generator.

2. The error assessment method for a test stimulus signal of an analog to digital converter according to claim 1, wherein the uniform-distribution code is generated by a hardware circuit.

3. The error assessment method for a test stimulus signal of an analog-digital converter according to claim 1, wherein the test pattern generator is a digital to analog converter.

4. The error assessment method for a test stimulus signal of an analog to digital converter according to claim 3, wherein when the analog to digital converter has a missing code, variation of an average of output signals of the analog to digital converter is calculated to correct the transition level of the digital to analog converter.
